(19) United States
(12) Patent Application Publication
(10) Pub. No.: US 2018/0150110 A1
(43) Pub. Date: May 31, 2018

(54) DISPLAY APPARATUS, IMAGE PROCESSING APPARATUS, AND NON-TRANSITORY COMPUTER READABLE MEDIUM

(71) Applicant: FUJI XEROX CO., LTD., Tokyo (JP)

(72) Inventors: Kengo TOKUCHI, Kanagawa (JP); Akihito YAMAUCHI, Kanagawa (JP)

(73) Assignee: FUJI XEROX CO., LTD., Tokyo (JP)

(21) Appl. No.: 15/594,804

(22) Filed: May 15, 2017

(30) Foreign Application Priority Data
Nov. 25, 2016 (JP) 2016-228648

(51) Int. Cl. G06F 1/16; G06F 3/041; G06F 3/0488

(52) U.S. Cl. CPC G06F 1/1652; G09G 2380/02; G06F 3/0488; G06F 3/041

(57) ABSTRACT

A display apparatus includes a display that is transformable in shape, an acquisition unit that acquires information related to a transformation of the display, and a rendering unit that changes display contents on the display in response to the acquired information.

### CROSS-REFERENCE TO RELATED APPLICATIONS

This application is based on and claims priority under 35 USC 119 from Japanese Patent Application No. 2016-228648 filed Nov. 25, 2016.

### BACKGROUND

### Technical Field

The present invention relates to a display apparatus, an image processing apparatus, and a non-transitory computer readable medium.

### SUMMARY

According to an aspect of the invention, there is provided a display apparatus. The display apparatus includes a display that is transformable in shape, an acquisition unit that acquires information related to a transformation of the display, and a rendering unit that changes display contents on the display in response to the acquired information.

### BRIEF DESCRIPTION OF THE DRAWINGS

Exemplary embodiments of the present invention will be described in detail based on the following figures, wherein:

FIG. 1 is an external view of a display apparatus that is transformable in shape;

FIG. 2 illustrates a hardware configuration of the display apparatus;

FIG. 3 illustrates a layout example of transformation detecting units;

FIG. 4 is a functional block diagram illustrating a controller for a function to changes display contents in response to a transformation of a display;

FIG. 5A through FIG. 5E illustrate relationships between detection location of transformation and bent locations;

FIG. 6 illustrates an operation to precisely input the bent location;

FIG. 7 is a flowchart illustrating a process executed by the controller;

FIG. 8 illustrates a transition of the display contents with a display mode to change the display contents selected on the display only while a bent state is detected;

FIG. 9 illustrates a transition of the display contents with the display mode to change the display contents selected on the display throughout a period of time from the beginning of the detection of a bent state to the detection of a next bent state;

FIG. 10 illustrates a transition of the display contents with the display mode to change the display contents selected on the display throughout a period of time from the end of the detection of a bent state to the detection of a next bent state;

FIG. 11 illustrates a usage example in which a specified bent location is used in editing an image;

FIG. 12 illustrates a usage example in which a specified bent location is used in editing another image;

FIG. 13A and FIG. 13B illustrate a display mode in which a user views three partition screens that are formed on the same side of a thin substrate when the thin substrate pulled out of a container is bent along two lines perpendicular to the direction of pulling (the three partition screens form a U-shaped configuration if viewed from above);

FIG. 14A and FIG. 14B illustrate a display mode in which a user views three partition screens from a point slantly above the bent location far from a container when a thin substrate pulled out of a container is bent along two lines perpendicular to the direction of pulling (the three partition screens form a U-shaped configuration if viewed from above);

FIG. 15A and FIG. 15B illustrate a display mode in which three users view three partition screens from three different directions when a thin substrate pulled out of a container is bent along two lines perpendicular to the direction of pulling (the three partition screens form a U-shaped configuration if viewed from above);

FIG. 16 illustrates a switching control operation of the display contents performed when a new bent location is detected at a position different from a partition screen that is currently displayed;

FIG. 17 is a flowchart generally illustrating a process of the controller that performs the switching control operation of display locations;

FIG. 18 illustrates a screen example that guides a user to a display mode specified by the user or a shape of the display appropriate for the reproduction of a display screen; and

FIG. 19 is a flowchart generally illustrating a process the controller that guides the user in operation.

### DETAILED DESCRIPTION

Exemplary embodiments of the present invention are described in detail with reference to the drawings.

### First Exemplary Embodiment

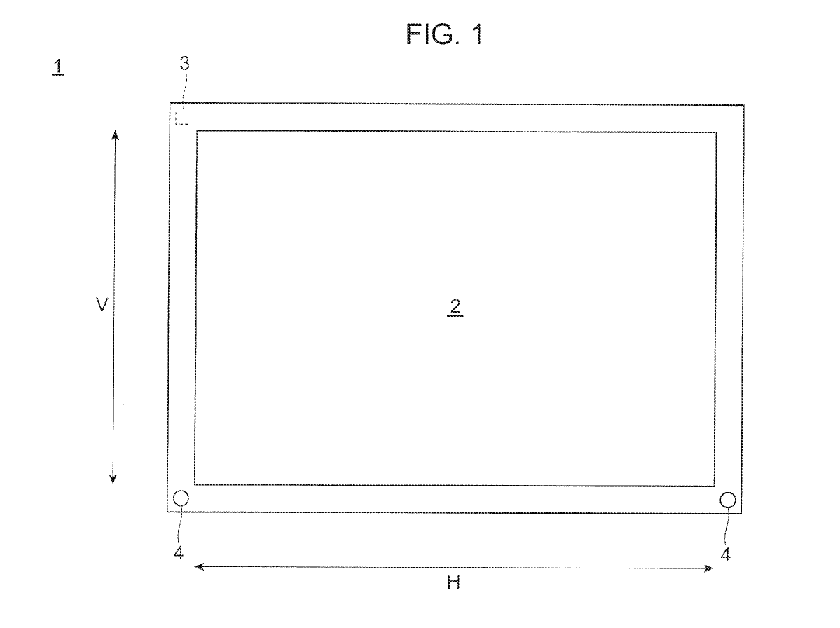

FIG. 1 is an external view of a display apparatus 1 that is transformable in shape. In accordance with the exemplary embodiment, the transformation of the display apparatus 1 includes bending the display apparatus 1 at any line or a predetermined line. FIG. 1 illustrates an external view of the display apparatus 1 prior to transformation. The display apparatus 1 placed on a flat surface has a planar shape as illustrated in FIG. 1. In accordance with the exemplary embodiment, the display apparatus 1 in a planar shape is referred to as being in a state prior to transformation.

The display apparatus 1 is manufactured by mounting on a flexible and thin plastic substrate a display 2 that displays an image and a controller 3 that generally controls the display apparatus 1. The display apparatus 1 is also referred to as a flexible display. In accordance with the exemplary embodiment, the display apparatus 1 having a display function is described. The display apparatus 1 of the exemplary embodiment includes an electronic apparatus that has a display function as long as the electronic apparatus is transformable in shape. For example, the display apparatus 1 may include a portable terminal apparatus.

The display 2 includes as a light emitting device an organic electroluminescent (EL) device or a liquid-crystal device. The display 2 is drive by a drive circuit (not illustrated). If the light emitting device is a liquid-crystal device, a light source (not illustrated) is also included.

The display apparatus 1 of the exemplary embodiment includes a speaker 4 and a device (not illustrated) that are used to output a sound. Referring to FIG. 1, right and left speakers 4 in pair are arranged on lower bottom corners of the display apparatus 1. The speakers 4 may not necessarily have to be mounted. In place of or in addition to the speakers 4, an audio port or an earphone jack may be mounted. The audio data may be wirelessly transmitted between the display apparatus 1 and an external apparatus.

The display screen of the display apparatus 1 (the screen on which the display 2 is mounted) has a rectangular shape. In accordance with the exemplary embodiment, the direction along the shorter side of the display apparatus 1 is referred to as a vertical direction V while the direction along the longer side of the display apparatus 1 is referred to as a horizontal direction H. The display apparatus 1 of the exemplary embodiment thus has the longer sides thereof in the horizontal direction H. Alternatively, the display apparatus 1 may have the longer sides thereof in the vertical direction V.

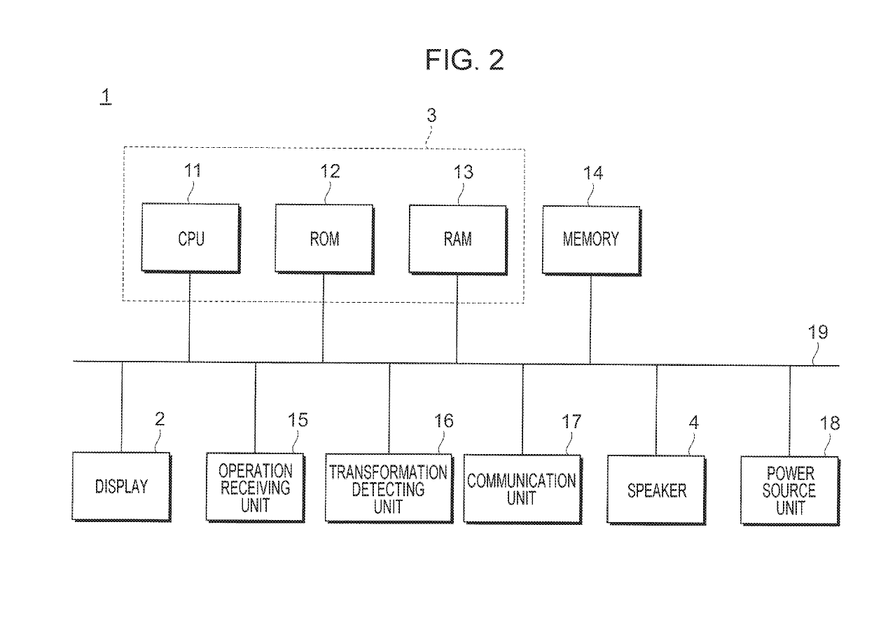

FIG. 2 illustrates a hardware configuration of the display apparatus 1. In addition to the devices described above, the display apparatus 1 includes a memory 14 that stores a variety of data, an operation receiving unit 15 that receives an operation performed by a user, plural transformation detecting units 16 that are used to detect a transformation of the display 2, a communication unit 17 that is used to communicate with an external apparatus, and a power source unit 18 that powers each unit in the display apparatus 1. These elements are interconnected to a bus 19, and data of the elements is exchanged via the bus 19.

The controller 3 is a computer. The controller 3 includes a central processing unit (CPU) 11 that executes a program, a read-only memory (ROM) 12 that stores programs including a basic input and output system (BIOS) and firmware, and data, and a random-access memory (RAM) 13 that serves as a working area of each program. The controller 3 of the exemplary embodiment functions as an example of an image processing apparatus.

The memory 14 includes a transformable storage device or a semiconductor memory that is manufactured using a printing technique. The operation receiving unit 15 of the exemplary embodiment includes a touchpanel sensor that detects a location touched by a finger of the user. The operation receiving unit 15 thus overlaid on the front surface of the display 2.

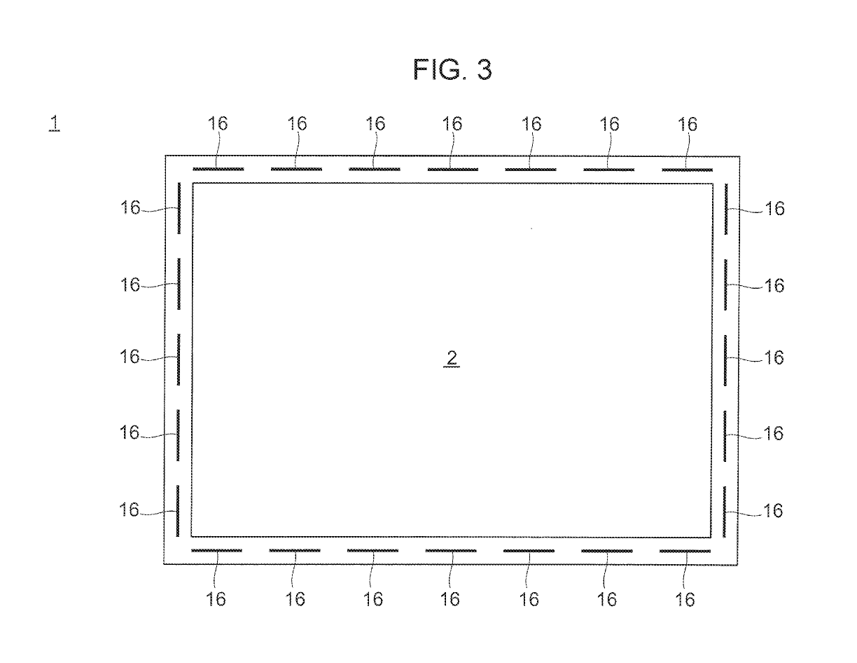

The transformation detecting unit 16 is a strain sensor. The strain sensor outputs a sensor output responsive to an amount of bend (angle). The strain sensor is thus a device that detects a transformation of bonded members. The transformation detecting unit 16 also detects a transformation caused by curving prior to a fold state. FIG. 3 illustrates a layout example of the transformation detecting units 16. Referring to FIG. 3, plural transformation detecting units 16 are laid out along each side of the display 2. The layout locations and layout intervals (layout density) of the transformation detecting units 16 are determined depending on the size and specifications of the strain sensor. In one arrangement, the transformation detecting units 16 may be overlaid on the display 2.

As will be described in detail below, the controller 3 estimates a bent location (namely, a fold location) of the display 2, in accordance with the positional relationship of the folding detected by the transformation detecting unit 16. In accordance with the exemplary embodiment, the transformation detecting units 16 are arranged on one surface of the display 2 (the front side surface, for example). Alternatively, the transformation detecting units 16 may be arranged on both side surfaces of the thin substrate. The communication unit 17 includes a communication interface. The power source unit 18 includes a power source integrated circuit.

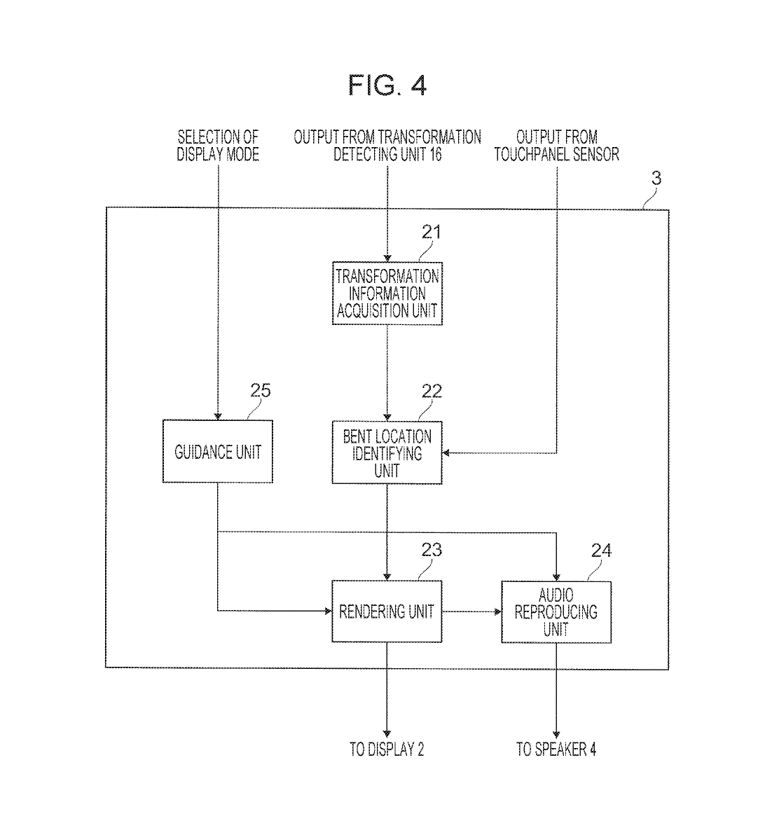

The functional configuration of the controller 3 is described. FIG. 4 is a functional block diagram illustrating the controller 3 that changes display contents in response to a transformation of the display 2. The function illustrated in FIG. 4 is implemented by the CPU 11 that executes a program.

The controller 3 includes a transformation information acquisition unit 21, a bent location identifying unit 22, a rendering unit 23, an audio reproducing unit 24, and a guidance unit 25. The transformation information acquisition unit 21 acquires the sensor outputs from the transformation detecting units 16, and detects the occurrence of a transformation. The bent location identifying unit 22 identifies a bent location of the display 2 in response to the positional relationship of the locations from which a transformation is detected. The rendering unit 23 adds a change to display contents in response to the identified bent location. The audio reproducing unit 24 outputs a voice or music from the speaker 4. The guidance unit 25 guides the user in the folding operation of the display 2.

In accordance with the exemplary embodiment, if a change exceeding a predetermined threshold value appears in the sensor output, the transformation information acquisition unit 21 determines that a transformation takes place at a location of the transformation detecting unit 16 responsive to the sensor output. If a change that has returned back to a value below the predetermined threshold value appears in the sensor output, the transformation information acquisition unit 21 determines that the transformation state at the location of the transformation detecting unit 16 responsive to the sensor output is canceled.

The transformation detecting units 16 smaller in sensor size may be densely arranged, and transformation detecting units 16 having detected a transformation may be spatially consecutive. In such a case, the transformation information acquisition unit 21 may determine to be a transformation location a location where a maximum sensor output of the sensor signals obtained from the consecutive transformation detecting units 16 is acquired.

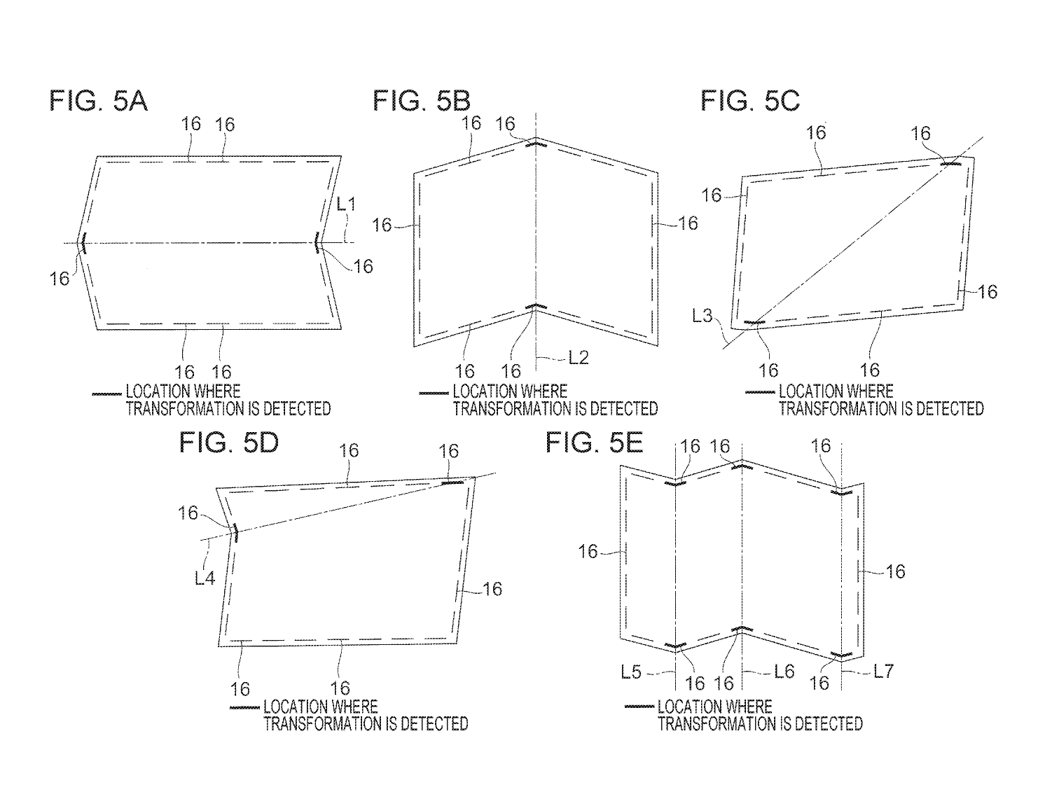

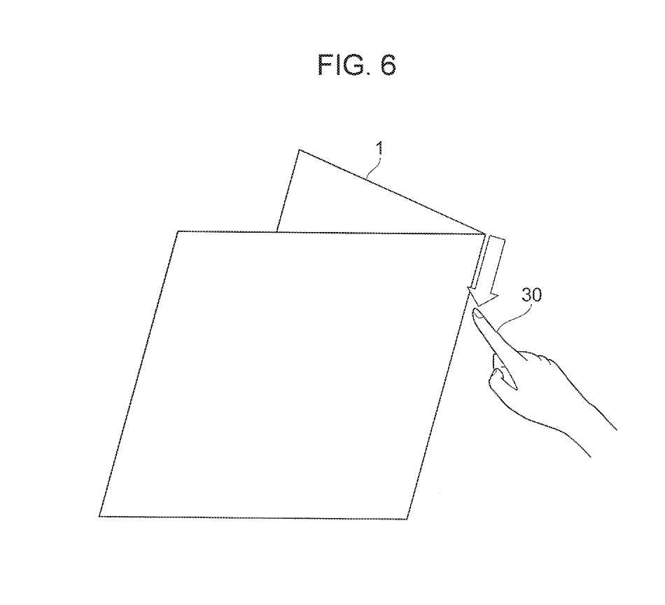

The bent location identifying unit 22 identifies a bent location of the display 2 in accordance with the positional relationship of the transformation detecting unit 16 that has detected a transformation. FIG. 5A through FIG. 5E and FIG. 6 illustrate the relationship between a detection location of transformation and a bent location. The bent location identifying unit 22 and the transformation information acquisition unit 21 are an example of an acquisition unit.

FIG. 5A illustrates a bent location that is identified by the bent location identifying unit 22 when the two transformation detecting units 16 at or near the center points of the shorter sides of the display apparatus 1 detect a transformation. Referring to FIG. 5A, the bent location identifying unit 22 determines that the display 2 is folded into half (horizontally folded) along a line L1 serving as a fold line in parallel with the longer sides of the display apparatus 1.

FIG. 5B illustrates a bent location that is identified by the bent location identifying unit 22 when a transformation is detected in the sensor outputs of the two transformation detecting units 16 at or near the center points of the longer sides of the display apparatus 1. Referring to FIG. 5B, the bent location identifying unit 22 determines that the display 2 is folded into half (vertically folded) along a line L2 serving as a fold line in parallel with the shorter sides of the display apparatus 1.

FIG. 5C illustrates a bent location that is identified by the bent location identifying unit 22 when a transformation is detected in the sensor outputs of the transformation detecting unit 16 at the top right corner of the display apparatus 1 and the transformation detecting unit 16 at the bottom left corner. Referring to FIG. 5C, the bent location identifying unit 22 determines that the display 2 is folded into half (diagonally folded) along a line L3 serving as a fold line that diagonally rises to the right.

FIG. 5D illustrates a bent location that is identified by the bent location identifying unit 22 when a transformation is detected in the sensor outputs of the transformation detecting unit 16 at the top right corner and the second transformation detecting unit 16 from the top left corner of the display apparatus 1. Referring to FIG. 5D, the bent location identifying unit 22 determines that the display 2 is folded into half (diagonally folded) along a line L4 serving as a fold line that is a diagonal side of the right-angled triangle having the right angle at the top left corner of the display apparatus 1.

FIG. 5E illustrates bent locations that are identified by the bent location identifying unit 22 when a transformation is detected in the sensor outputs of the three transformation detecting units 16 at three points along the top side and the three transformation detecting units 16 at three points along the bottom side of the display apparatus 1. Referring to FIG. 5E, the bent location identifying unit 22 determines that the display 2 is folded into three along a line L5 in an inverted V shape in cross-section, along a line L6 in a V shape in cross-section, and along a line L7 in an inverted V shape in cross-section.

FIG. 6 illustrates an operation to precisely input the bent location. The bent location may be detected using only the locations of the transformation detecting units 16 that have detected a transformation. If the number of arranged transformation detecting units 16 is smaller (with less density of the transformation detecting units 16), there is a possibility that an identified bent location is deviated from an actual bent location. In that case, the sensor output of the touchpanel serving as an example of the operation receiving unit 15 is used as an output of the bent location as illustrated in FIG. 6. If a sensor output is received from the touchpanel sensor with the transformation detected by the transformation detecting unit 16, the bent location identifying unit 22 identifies as a bent location a moving trajectory of a finger 30 that has moved along the ridge of the display apparatus 1.

Turning to FIG. 4, the rendering unit 23 displays on the display 2 an image that has been changed in response to the bent location identified by the bent location identifying unit 22. For example, the rendering unit 23 partitions the display 2 into plural partition screens that are delineated by the identified bent locations, and displays different images on different partition screens. Also, the rendering unit 23 displays, on the display 2, an image that has been edited in terms of a region at the identified bent locations, from among the images displayed on the display 2. The bent locations include not only a bent location identified in real time but also a stored bent location (history of transformation). Any bent location is an example of information related to the transformation. The process related to these operations is described in detail below.

The audio reproducing unit 24 has a function to output to the speaker 4 an audio signal responsive to an image displayed on the display 2. The guidance unit 25 has a function to guide the user how to perform a bending operation on the display 2 so that a bent state to achieve a display mode desired by the user is established. The guidance technique is based on a method using an image or a method using a sound.

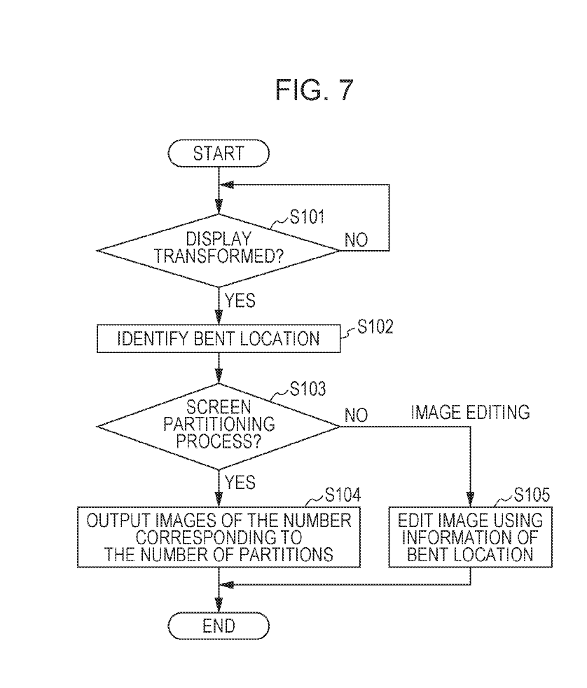

The process to be performed by the controller 3 of the exemplary embodiment is described below. FIG. 7 is a flowchart illustrating the process to be performed by the controller 3. The controller 3 monitors the sensor outputs from the transformation detecting units 16 arranged on the display 2, and determines whether the display 2 has been transformed (step S101). The transformation information acquisition unit 21 performs the monitoring operation. While a non-affirmative answer is repeated in the determination operation in step S101, the transformation information acquisition unit 21 repeats the determination operation in step S101. If a change leading to a value above a threshold value appears in the sensor output, the transformation information acquisition unit 21 obtains an affirmative answer to the determination operation in step S101, and proceeds to step S102.

The controller 3 identifies the bent location of the display 2 using position information of the transformation detecting unit 16 that has detected a transformation (step S102). The bent location identifying unit 22 is used to identify the bent location. The controller 3 determines whether to use the identified bent location in a screen partitioning process (step S103). The rendering unit 23 is used in this determination operation. What process the identified bent location is used in is desirably to be input by the user in advance.

If an affirmative answer is obtained in the determination operation in step S103, the rendering unit 23 outputs, respectively to the partition screens, images of the number corresponding to the number of screen partitions determined by the identified bent locations (step S104). In this case, the rendering unit 23 determines contents of each image to be output to each partition screen, based on parameters, such as the size and shape of each of the partition screens having a border as the identified bent locations, and the aspect ratio and number of pixels of each partition screen.

The rendering unit 23 performs image switching during each of the following time periods.

(1) Time period of the detection of a current bent state
(2) Time period extending from the beginning of the detection of a current bent state to the detection of a next bent state (history information of transformation is also used)
(3) Time period extending from the end of the detection of a current bent state to the detection of a next bent state (only history information of transformation is used)

The end of the image switching is not limited to the detection of the next bent state. For example, the image switching may be ended after the display time elapse predetermined by the user, or in response to an end command from the user.

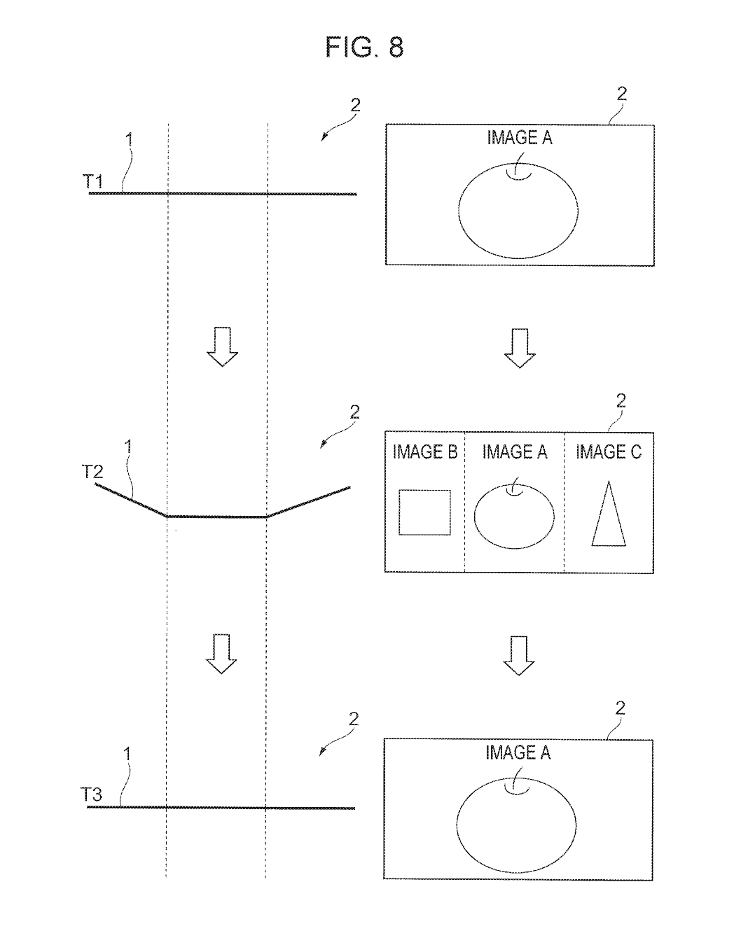

FIG. 8 illustrates a transition of the display contents with a display mode to change the display contents of the display 2 selected only while a bent state is being detected. Referring to FIG. 8, the display 2 displays a picture of an apple (hereinafter referred to as an “image A”) at time point T1 prior to the transformation of the display 2.

Referring to FIG. 8, the display 2 is bent into two along two fold lines that are in parallel with the shorter sides of the display 2 at time point T2. When the display 2 is bent inwardly along the two fold lines perpendicular to the longer sides of the display 2, the screen of the display 2 is partitioned into three partition screens. The rendering unit 23 determines the images that are to be displayed on the three partition screens, depending on the size, shape, and the like of the partition screens. In the example of FIG. 8, the image A is displayed on the center partition screen, an image of a square (hereinafter referred to as an “image B”) is displayed on the left partition screen, and an image of a triangle (hereinafter referred to as an “image C”) is displayed on the right partition screen.

At time point T3 thereafter, the display 2 reverts back to the original flat state. In this state, the rendering unit 23 treats the display 2 as a single screen, thereby displaying the image A only. In this display method, the time period during which the display 2 is bent by the user matches the transition period of the display contents.

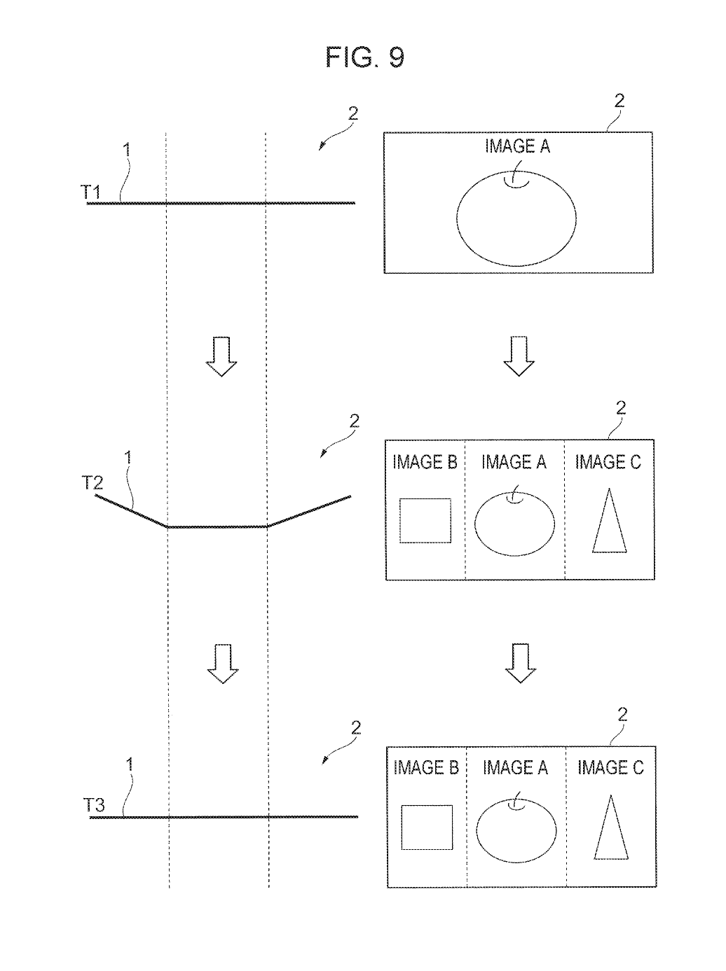

FIG. 9 illustrates a transition of the display contents with the display mode to change the display contents selected on the display throughout a period of time from the beginning of the detection of a bent state to the detection of a next bent state. Referring to FIG. 9, the display 2 displays the image A only at time point T1 prior to the transformation of the display 2. In this condition, the display 2 may now be bent in the same way as in FIG. 8. More specifically, the screen of the display 2 is partitioned into three partition screens at time point T2. In the same way as in the example of FIG. 8, the rendering unit 23 displays the image A on the center partition screen, the image B on the left partition screen, and the image C on the right partition screen.

When the display 2 reverts back to the flat state at time point T3 thereafter, the rendering unit 23 maintains the immediately prior display contents as illustrated in FIG. 9. More specifically, when the bent state is no longer detected, information with the transformation detected (history information) is used to display the image A on the center partition screen, the image B on the left partition screen, and the image C on the right partition screen. In this display method, the display contents continue to be displayed not only during the time period throughout which the user is bending the display 2 but also the display contents continue to be displayed subsequent to the end of the bending using the history information.

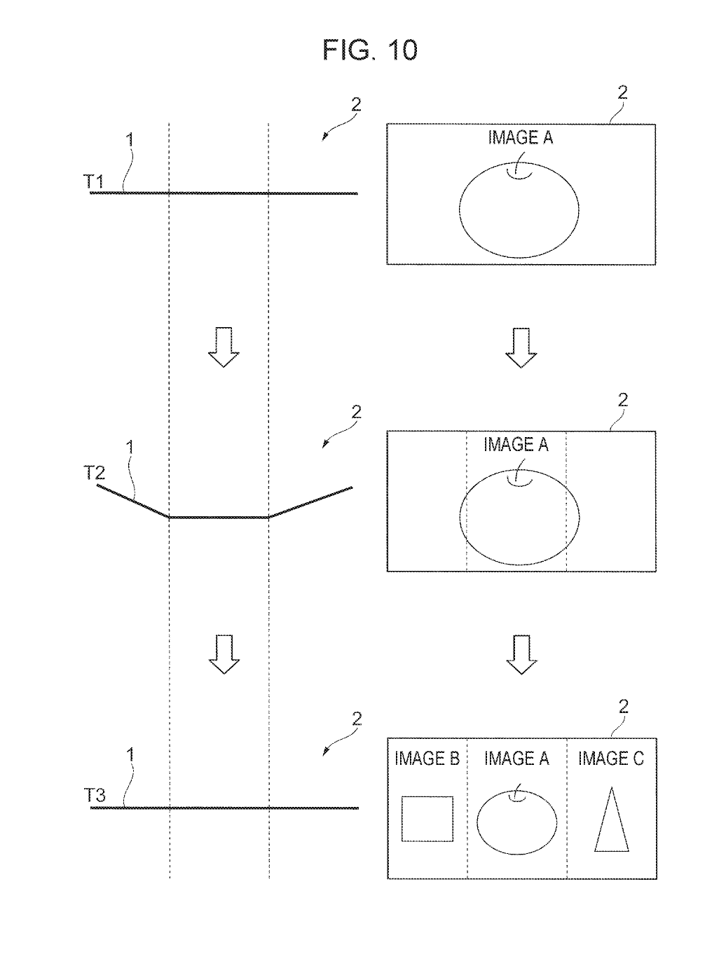

FIG. 10 illustrates a transition of the display contents with the display mode to change the display contents selected on the display throughout a period of time from the end of the detection of a bent state to the detection of a next bent state. The display contents of FIG. 10 at time point T1 remain unchanged from those of FIG. 9. In the case of FIG. 10, however, the display screen of the display 2 is not partitioned after the display 2 is bent and only the image A remains displayed.

At time point T3 when the display 2 reverts back from the bent state to the flat state and thereafter, the display 2 is partitioned into three partition screens and image displaying responsive to each partition screen is performed. More specifically, the rendering unit 23 displays the image A on the center partition screen, the image B on the left partition screen, and the image C on the right partition screen. Referring to FIG. 10, the user bends the display 2 only to input a border between the partition screens, and the viewing of the images is performed after the display 2 reverts back to the flat state.

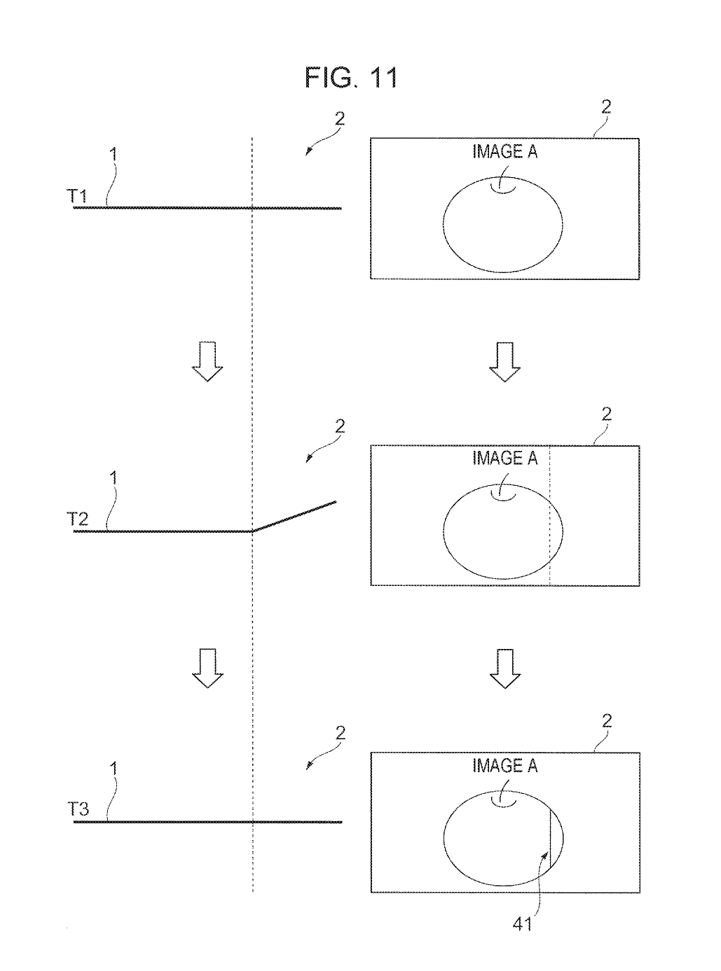

Turning back to FIG. 7, if an affirmative answer results in the determination operation in step S103, the rendering unit 23 shifts to a mode to use the identified bent location in image editing (step S105). More specifically, the rendering unit 23 shifts to the mode in which the image being displayed is edited using the identified bent location. FIG. 11 illustrates a usage example in which a specified bent location is used in editing an image. As illustrated in FIG. 11, only the image A is displayed on the display 2 at time point T1 prior to the transformation of the display 2. At the next time point T2, the display 2 is bent inwardly along a line more rightward from the center line of the screen. At this time point, no change occurs in the image A.

At the next time point T3, the display 2 reverts back to the flat state. A line segment 41 is added on the image of the apple corresponding to the bent location (fold line location) in the image A at time point T2. As illustrated in FIG. 11, the bent location is input as an operation to add the line segment 41. Referring to FIG. 11, the line segment 41 starts to be displayed after the bent state is detected. As an operation example, as illustrated by time point T2 in FIG. 8, the line segment 41 may be displayed only while the bent state is being detected. As another operation example, as illustrated in FIG. 9, the line segment 41 may be displayed at time point T2 when the bent state is detected or at time point T3 when the detection of the bent state is complete.

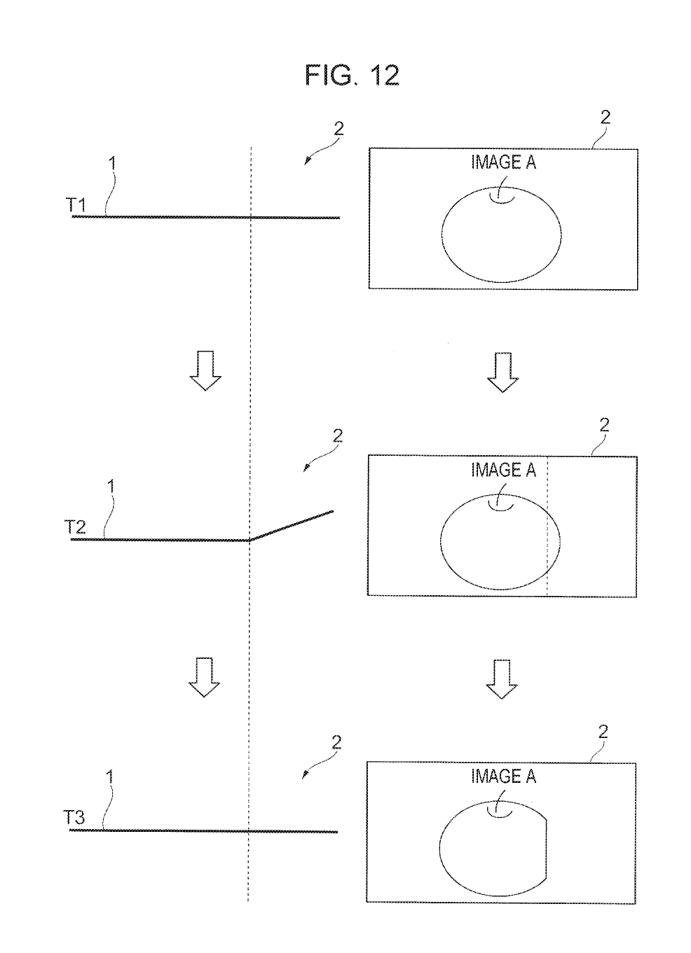

FIG. 12 illustrates a usage example in which a specified bent location is used in editing another image. As illustrated in FIG. 12, as well, a bending operation similar to the bending operation of FIG. 11 is performed on the display 2 in the order of time points T1, T2, and T3. FIG. 12, however, illustrates the image of the apple that is cut along the identified bent line at time point T3. More specifically, as illustrated in FIG. 12, the bending operation of the display 2 performed by the user is used to input a region where a special effect (cutting operation) is applied.

FIG. 12 illustrates only the image after the cutting operation. Alternatively, a process from the beginning of the cutting operation to the completion of the cutting operation may be displayed as a moving image. A cut surface of the apple, not illustrated in FIG. 12, may be displayed. The displayed cut surface gives the user more realistic feeling of image processing. In accordance with the exemplary embodiment, contents of the special effects to be applied are specified by the user in advance. In accordance with the exemplary embodiment, the cutting operation is described as an example of the special effect. If the display 2 is rounded in transformation by hand and the bent location identifying unit 22 detects the transformation location in response to the sensor output from the transformation detecting unit 16, the apple image may be displayed as if crumpled in the image processing.

During the image editing, a sound effect responsive to the contents of the image editing may be provided. For example, in the case of FIG. 12, the sound effect, such as a cutting sound of the apple, may be emitted from the speaker 4. The use of the sound effect gives the user more realistic feeling of the image processing.

### Second Exemplary Embodiment

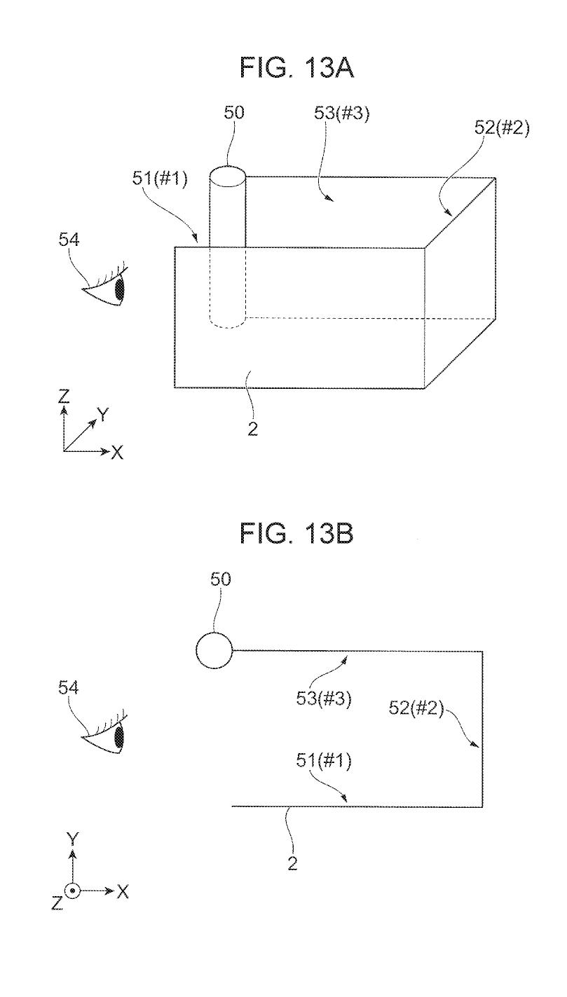

A second exemplary embodiment is related to a switching technique of an output location of an image responsive to an eyeball position of the user (observation position). The second exemplary embodiment is described with reference to FIG. 13A through FIG. 15B. As illustrated in FIG. 13A through FIG. 15B, the display apparatus 1 that is transformable is pulled from a retracted state in a container 50 for use. FIG. 13A through FIG. 15B are represented using the XYZ coordinate system. The Z axis is aligned with the direction of height, and the X axis and the Y axis are the two directions that define a horizontal plane. Referring to FIG. 13A through FIG. 15B, three partition screens are designated a first partition screen (#1), a second partition screen (#2), and a third partition screen (#3) in the order from a far position to a near position to the container 50.

FIG. 13A and FIG. 13B illustrate a display mode in which the user views three partition screens 51, 52, and 53 that are formed on the same side of a thin substrate when the display 2 pulled out of the container 50 is bent along two lines perpendicular to the direction of pulling (the three partition screens 51, 52, and 53 form a U-shaped configuration if viewed from above). The eyeball of the user is represented by an observation position 54 of the user as illustrated in FIG. 13A and FIG. 13B. In FIG. 13A and FIG. 13B, the display 2 is bent twice in the direction of pulling at the right angle. The angle made by two adjacent surfaces at the bent location is not necessarily the right angle. The angle made by two adjacent surfaces may be an obtuse angle.

Referring to FIG. 13A and FIG. 13B, different images are respectively displayed on different partition screens 51, 52, and 53 while the display 2 is bent. For example, a front scene is displayed on the partition screen 52 in front of the user, a right scene is displayed on the right partition screen 51, and a left scene is displayed on the left partition screen 53. The observation position 54 of FIG. 13A and FIG. 13B may be set up when the display 2 is disposed on one surface or both surfaces of the thin substrate forming the display apparatus 1. In accordance with the exemplary embodiment, the user sets up the observation position 54 in advance on the display apparatus 1. If a line-of-sight sensor that detects the line of sight of the user is disposed in part of the container 50 or the display apparatus 1, the observation position 54 may be identified using the detection results.

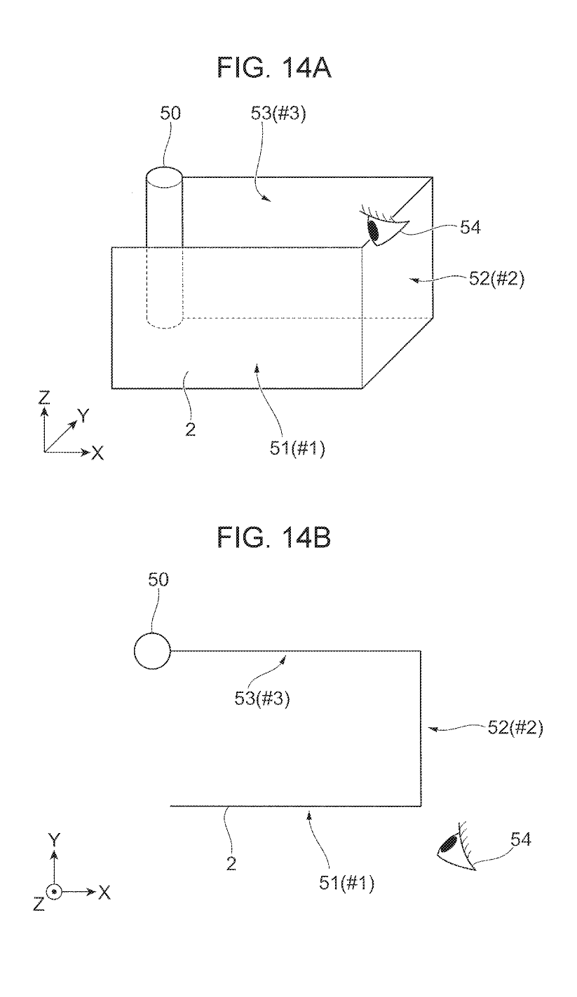

FIG. 14A and FIG. 14B illustrate a display mode in which the user views three partition screens 51, 52, and 53 from a point slantly above the bent location far from the container 50 when the display 2 pulled out of the container 50 is bent along two lines perpendicular to the direction of pulling (the three partition screens 51, 52, and 53 form a U-shaped configuration if viewed from above).

The observation position 54 of FIG. 14A and FIG. 14B may be set up if the display 2 is disposed on both surfaces of the thin substrate forming the display apparatus 1. Referring to FIG. 14A and FIG. 14B, the user may view two partition screens of the display 2 (partition screens 51 and 52) arranged on the outside surface of the bent thin substrate, and one partition screen of the display 2 (partition screen 53) arranged on the inside surface of the bent thin substrate. Referring to FIG. 14A and FIG. 14B, the display 2 is bent twice in the direction of pulling, namely along two lines, at the right angle. The angle made by two adjacent surfaces at the bent line is not necessarily the right angle.

In the case of FIG. 14A and FIG. 14B, the user sets up the observation position 54 in advance on the display apparatus 1. If a line-of-sight sensor that detects the line of sight of the user is disposed in part of the container 50 or the display apparatus 1, the observation position 54 may be identified using the detection results. In FIG. 14A and FIG. 14B, as well, different images are respectively displayed on the partition screens 51, 52, and 53 while the display 2 is bent.

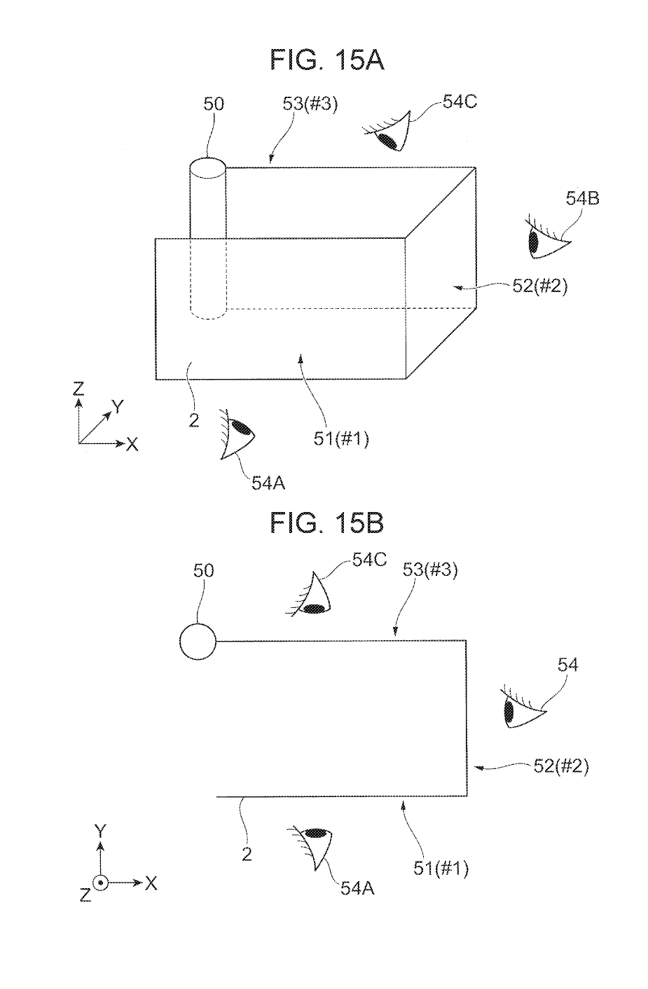

FIG. 15A and FIG. 15B illustrate a display mode in which three users view three partition screens 51, 52, and 53 from three different points when the display 2 pulled out of the container 50 is bent along two lines perpendicular to the direction of pulling (the three partition screens 51, 52, and 53 form a U-shaped configuration if viewed from above).

The observation position 54 of FIG. 15A and FIG. 15B is set up regardless of whether the display 2 is disposed on one surface or both surfaces of the thin substrate forming the display apparatus 1. Referring to FIG. 15A and FIG. 15B, the users view the three partition screens 51, 52, and 53 of the display 2 arranged to be on the same side of the thin substrate (including the outside surfaces in the bent state of the display 2). Referring to FIG. 15A and FIG. 15B, the display 2 is bent twice in the direction of pulling, namely along two lines, at the right angle. The angle made by two adjacent surfaces at the bent line is not necessarily the right angle.

Referring to FIG. 15A and FIG. 15B, the images dedicated to the three persons corresponding to the observation positions 54 may be respectively displayed on the three partition screens 51, 52, and 53. For example, a television image of a channel A is displayed on the partition screen 51 corresponding to the observation position 54A, an operation screen of a personal computer is displayed on the partition screen 52 corresponding to the observation position 54B, and a television image of a channel C is displayed on the partition screen 53 corresponding to the observation position 54C.

In the case of FIG. 15A and FIG. 15B, the user sets up the observation position 54 in advance on the display apparatus 1. If a line-of-sight sensor that detects the line of sight of the user is disposed in part of the container 50 or the display apparatus 1, the observation position 54 may be identified using the detection results. In FIG. 15A and FIG. 15B, as well, different images are respectively displayed on the partition screens 51, 52, and 53 while the display 2 is bent.

### Third Exemplary Embodiment

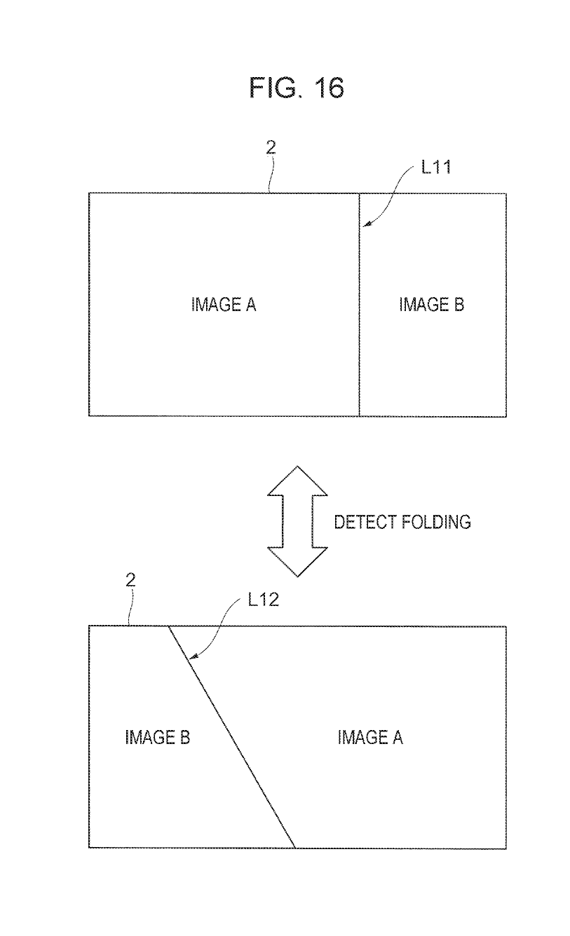

A third exemplary embodiment is related to a switching of the display contents between the partition screens that is triggered by the transformation of the display 2. FIG. 16 illustrates a switching control operation of display contents performed when a new bent location is detected at a position different from a partition screen that is currently displayed. As illustrated in the upper portion of FIG. 16, the image A is displayed on the left partition screen, and the image B is displayed on the right partition screen. In such a case, a line L11 serving as a border between the two partition screens is in parallel with the shorter sides of the display 2. On the other hand, FIG. 16 illustrates, in the lower portion thereof, the display contents in which L12 drawn along a new line different from the line L11 is detected. In the lower portion of FIG. 16, the image B is displayed on the left partition screen, and the image A is displayed on the right partition screen. In this way, the display contents are switched between the right partition screen and the left partition screen in response to the detection of the new bent location.

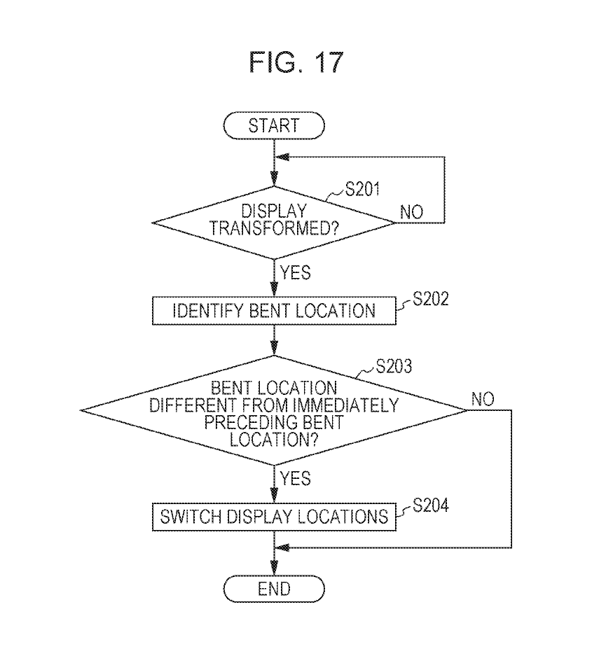

FIG. 17 is a flowchart illustrating a process of the controller 3 that performs the switching control operation of display locations. The controller 3 monitors a sensor output from the transformation detecting unit 16 disposed on the display 2, and determines whether the display 2 has been transformed or not (step S201). The transformation information acquisition unit 21 is used in this monitoring operation. While a non-affirmative answer is consecutively repeated in step S201, the transformation information acquisition unit 21 repeats the determination operation in step S201. If a change leading to a value exceeding a threshold value appears in the sensor output, the transformation information acquisition unit 21 results in an affirmative answer in step S201 and proceeds to step S202.

The controller 3 identifies the bent location of the display 2 using the position information of the transformation detecting unit 16 where a transformation is detected (step S202). In this identifying operation, the function of the bent location identifying unit 22 is used. The controller 3 determines whether the identified bent location is different from the immediately preceding bent location (step S203). The function of the rendering unit 23 is used to perform this determination operation. If an affirmative answer results in the determination operation in step S203, the rendering unit 23 switches the images between the partition screens delineated by the new bent location (step S204). If a non-affirmative answer results in the determination operation, the rendering unit 23 continues to perform the current displaying.

### Fourth Exemplary Embodiment

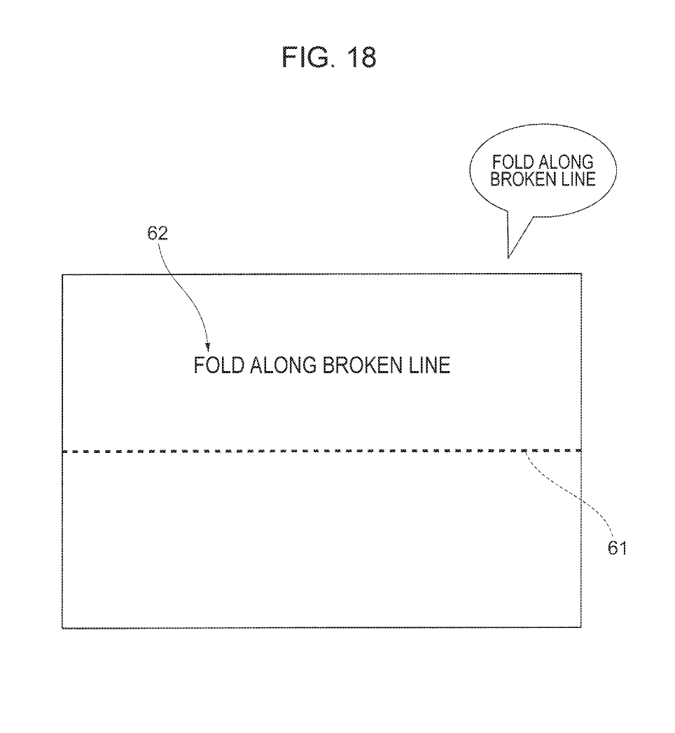

A fourth exemplary embodiment relates to a display mode desired by the user (the number and layout of partition screens used in the image displaying desired by the user), and a function to guide the user to a transformation operation of the display 2 to provide a display appropriate for an image selected by the user. FIG. 18 illustrates a screen example that guides the user to a shape of the display 2 appropriate for the display mode specified by the user.

The screen example of FIG. 18 indicates an operation example that is intended to display different images between the upper portion and the lower portion of the display 2. In accordance with the fourth exemplary embodiment, a broken line 61 is displayed along an approximately center line extending in parallel with the longer sides of the display 2 and a guidance message 62 is displayed to indicate job contents of the user. FIG. 18 does not clarify whether the display 2 is bent in a V shape or an inverted V shape in cross-section. When the guidance message 62 is displayed, the contents of the guidance message 62 are desirably output in audio sound.

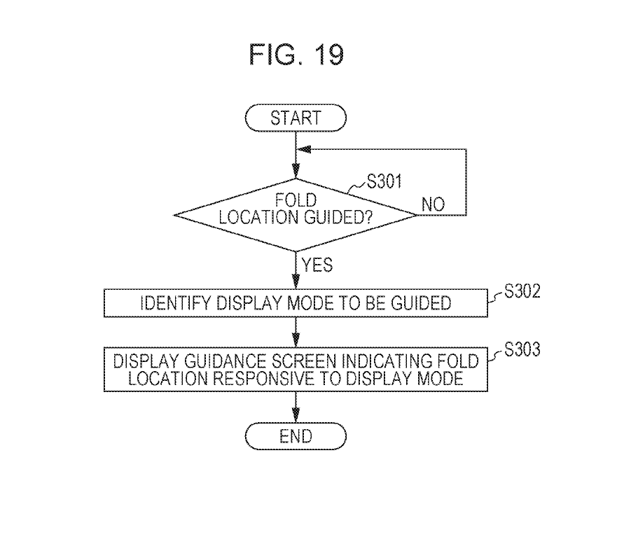

FIG. 19 is a flowchart generally illustrating a process the controller 3 performs to guide the user in operation. The process is performed by the guidance unit 25. The guidance unit 25 determines whether guidance for the bent location is requested or not (step S301). If a non-affirmative answer is repeatedly obtained, the guidance unit 25 repeats the determination operation in step S301.

If an affirmative answer is obtained, the guidance unit 25 identifies a display mode for guidance (step S302). For example, the guidance unit 25 identifies the display mode specified by the user from among multiple display modes displayed on the display 2. The guidance unit 25 displays on the display 2 a guidance screen (see FIG. 18) that indicates the bent location responsive to the identified display mode (step S303).

The guidance screen is intuitively recognizable. By guiding the user to the bent location that is appropriate for the contents of the displayed image, the user may transform the display 2 in a shape suited for the observation of the image in a short period of time.

### OTHER EXEMPLARY EMBODIMENTS

In accordance with the exemplary embodiments described above, the image to be displayed on the display 2 is changed depending on the transformation operation of the display 2. An incidental sound may be reproduced for an image that is displayed on a partition screen at a specific location. If the speakers 4 are arranged at respective positions thereof on the partition screens, the incidental sounds of the images displayed on the partition screens may be reproduced through the speakers 4 responsive to the partition screens. More specifically, a different sound may be reproduced on a different partition screen.

In accordance with the exemplary embodiments, only the output form of the display screen is described. A reproduction speed of the display screen of a partition screen at a specific location (such as a center partition screen out of the left, center, and right partition screens) from among plural partition screens formed by the display 2 may be modified. For example, the image displayed on the center partition screen is played at a double speed, at a slow-motion speed, or on a frame-by-frame basis.

In accordance with the exemplary embodiments, the display 2 and the controller 3 are integrated into a unitary module. Alternatively, the display 2 (including a communication unit) may be a projector type apparatus separated from the controller 3. In this configuration, the display 2 may be a projector screen or an aerial image display.

If the display 2 is a projector screen, plural transformation detecting units 16 and a communication unit are mounted on a sheet screen. The communication unit of the display 2 is used to transmit the sensor output from the transformation detecting unit 16 to the controller 3. On the other hand, if the display 2 is an aerial image display, the display 2 is implemented as a mirror image. More specifically, the display 2 as an aerial image display is present in visual perception and is not a physical presence. The transformation detecting unit 16 used in the display 2 serving as an aerial image display is arranged around the display 2 as an imaging camera that image-captures a gesture of a user who bends a display screen, or as a sensor that detects a fluctuation (such as an air fluctuation or wind) occurring in response to the gesture. The sensor output from the transformation detecting unit 16 is output to the controller 3 via the communication unit.

In the above exemplary embodiments, the controller 3 is included in an image processing apparatus that is configured in a separate casing. The rendering unit 23 of the previous exemplary embodiments controls a light projector (including a light source and an optical system) included in the image processing apparatus, thereby changing contents of an image to be projected onto the surface of the display 2 (projection plane).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A display apparatus comprising:
a display that is transformable in shape;
an acquisition unit that acquires information related to a transformation of the display; and
a rendering unit that changes display contents on the display in response to the acquired information.

2. The display apparatus according to claim 1, wherein the rendering unit changes the display contents on the display in response to information concerning a bent location of the display.

3. The display apparatus according to claim 2, wherein the rendering unit partitions a display surface of the display at a bent location into a plurality of screens, and respectively displays different images on different screens.

4. The display apparatus according to claim 3, wherein the rendering unit determines an image to be displayed on the screen in response to a shape of the screen.

5. The display apparatus according to claim 2, wherein the rendering unit performs an edit operation on a display image using information concerning the bent location.

6. The display apparatus according to claim 5, wherein the rendering unit adds a special effect on the display image in the edit operation.

7. The display apparatus according to claim 6, further comprising an audio reproducing unit that generates a sound in response to a transformation of the display image.

8. The display apparatus according to claim 1, further comprising a guidance unit that guides how to transform the display.

9. The display apparatus according to claim 8, wherein the guidance unit displays the bent location on the screen of the display.

10. An image processing apparatus comprising a rendering unit that changes display contents on a display in response to information concerning a transformation of the display that is transformable in shape.

11. The image processing apparatus according to claim 10, wherein the rendering unit projects the display contents onto the display that is separated from the image processing apparatus.

12. The image processing apparatus according to claim 10, wherein the rendering unit displays the display contents onto the display that is an aerial image display.

13. A non-transitory computer readable medium storing a program causing a computer to execute a process for processing an image, the process comprising changing display contents on a display in response to information concerning a transformation of the display that is transformable in shape.
